(19) United States
(12) Patent Application Publication
(10) Pub. No.: US 2007/0249369 A1
(43) Pub. Date: Oct. 25, 2007

(54) System and Methods for Dialing Code Initiated Mobile Search

(76) Inventor: Dennis Becker, San Diego, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/740,255

(22) Filed: Apr. 25, 2007

Related U.S. Application Data
(60) Provisional application No. 60/794,984, filed on Apr. 25, 2006.

(51) Int. Cl. H04Q 7/20

(52) U.S. Cl. 455/457

(57) ABSTRACT

A system, method and apparatus for delivering Web content to a mobile telephone or related device by using a dialing code is provided. In an exemplary embodiment, a user who dials a telephone number, or other dialing code, and subsequently receives content sent to the user's mobile handset. In another embodiment, content is Web content sent to the user's phone via a Wireless Application Protocol (WAP) process. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### CROSS REFERENCE TO RELATED APPLICATIONS

This application claims the benefit of priority of co-pending U.S. Provisional Patent Application Ser. No. 60/794,984 entitled “PHONE NUMBER INITIATED MOBILE SEARCH”, by Dennis Becker, filed Apr. 25, 2006. Priority of the filing date of Apr. 25, 2006 is hereby claimed, and the disclosure of the Provisional Patent Application is hereby incorporated by reference in its entirety.

The present application is additionally related to commonly owned and assigned U.S. patent application Ser. No. 11/539,860 entitled “MULTI-MODAL SYSTEM FOR REQUESTING AND DELIVERING WEB CONTENT”, filed Oct. 9, 2006, the entire contents of which are hereby incorporated by reference.

### FIELD OF THE INVENTION

The present invention generally relates to systems and methods for delivery of content to mobile devices. More particularly, the invention concerns a system, methods and apparatus for delivery of Web content to a mobile electronic device.

### BACKGROUND OF THE INVENTION

Often times mobile device users seek instant and relevant information. For example, device users may seek information pertaining to venues ranging from restaurants to movie show times. Current information sources include directory assistance type services, local dial-in concierge services, newspaper and other print publications, and local billboard advertising, to name a few. With the explosive growth of data enabled mobile handsets, a unique opportunity exists to supply relevant information to these handsets.

Currently, mobile handset users can access information (“mobile content”) on the Internet via a wireless data connection. A Wireless Application Protocol (WAP) browser is the most commonly used interface for viewing mobile content. Due to the nature of most mobile handsets, many of which do not have a keyboard input, navigating and accessing mobile content is extremely cumbersome and subsequently rarely used.

One category of mobile content that is creating demand to overcome the drawbacks of data-enabled handsets, is mobile search. Mobile search allows the mobile user to receive instant, relevant information relating to a “key word”. As described above, the limited input interface of a mobile device impairs the speed and usability of a mobile search. To address this problem, voice recognition technology is being developed in efforts to provide mobile search via spoken commands. The state of the art for voice recognition is plagued with speech pattern recognition shortfalls and disrupted voice recognition dialog from background noise. Currently, voice recognition falls short of providing a viable alternative to the push button interface of mobile handsets.

Although present devices are somewhat functional, they are not sufficiently accurate or otherwise satisfactory. Therefore there exists a need for a system, and methods for improved search from mobile devices.

### SUMMARY OF THE INVENTION

Exemplary embodiments that are depicted in the drawings are summarized below. These and other embodiments are more fully described in the Detailed Description of the Invention section. It is to be understood, however, that there is no intention to limit the invention to the embodiments described in this Summary of the Invention or in the Detailed Description. One skilled in the art will recognize that there are numerous modifications, equivalents, and alternative constructions that fall within the spirit and scope of the invention as expressed in the claims.

The present invention provides a system, apparatus and methods for overcoming some of the difficulties presented in the Background of the Invention. In an exemplary embodiment, a method of retrieving information on a portable electronic device is provided. The method involves transmitting a first signal to a network from a portable electronic device. In some embodiments this first signal may include a unique identifier that relates to a geographical location. A mobile search apparatus on the network receives the signal. An exemplary mobile search apparatus consistent with various embodiments may include a computer with a database containing geographically referenced categories of data. The computer may contain a network connection to transmit and receive signals to devices on the network. In one embodiment, the mobile search apparatus is configured to transmit a second signal to the portable electronic device. In this embodiment, the second signal may contain data content from the database. One feature of this embodiment is that it provides a method of searching for geographically relevant information from a mobile device.

In another embodiment, a communication network is provided. Novel features of the communication network include, but are not limited to, a configuration of devices on the network that allows portable electronic devices to conduct searches for geographically relevant data. In this embodiment, a portable electronic device communicates with a mobile search apparatus on the network. The portable electronic device and the mobile search apparatus conduct the communication through the transmission and reception of various communication signals. For example, the portable electronic device may transmit a signal containing a unique identifier to the mobile search apparatus. The mobile search apparatus may receive the signal and respond with data from its database. In one embodiment, the mobile search apparatus may contain data content arranged by geographical region. The portable electronic device may receive the signal from the search apparatus and display the contents of the signal or in the case of voice data play the voice data on a speaker. In one embodiment, a user may select from the data provided by the search apparatus to receive additional information. In this case, further communication signals may be exchanged between the portable electronic device and the mobile search apparatus.

In a still further embodiment, a mobile search apparatus is provided. The mobile search apparatus may include a processor, a network interface, and some form of storage media. In some embodiments, the mobile search apparatus may be a computer configured to provide search services to portable electronic devices on the network through an exchange of communication signals to and from the portable electronic device.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates a block diagram showing an exemplary embodiment of communication system;

FIG. 2 illustrates a process flow diagram representative of the operation of an exemplary embodiment of a provided method;

FIG. 3 illustrates a process flow diagram representative of the operation of another exemplary embodiment;

FIG. 4 illustrates a process flow diagram representative of the operation of a further exemplary embodiment;

FIG. 5 illustrates a block diagram of a mobile search apparatus; and

FIG. 6 illustrates a process flow diagram representative of operation of another exemplary embodiment.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In a mobile society the demand for information can pose significant limitations on a user. Portable electronic devices have significant capabilities that may be useful in providing this information. One current limitation to accessing relevant information is limited in the sense that the information a user may deem relevant may be constrained to a geographical area. Further, the use of portable electronic devices to search the web through the use of web-browsers enabled with Wireless Application Protocol (WAP). While WAP browsers are useful, structural limitations on portable devices may preclude or substantially limit a users ability to retrieve data. Additionally, the data once retrieved may not be relevant to the users geographical area.

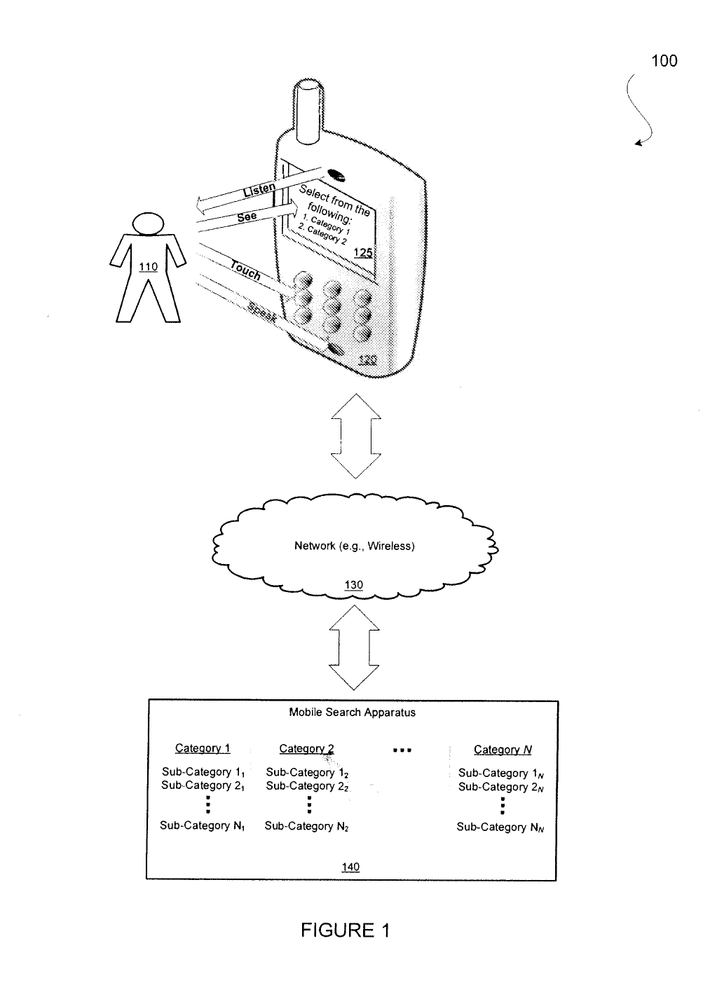

Provided embodiments address these issues, for example, as shown in FIG. 1, a user 110 may interact with a handheld device 120. The interaction between the user 110 and the handheld device 120 may occur via audio, visual, speech and/or touch information and/or commands. The portable electronic device 120 may be any of a variety of communication devices used to receive and transmit communication-related data via a network 130. For example, portable electronic device 120 may be a cell phone, a PDA, a telephone, a computer, a laptop, a handheld communication device or other like device that receives and transmits data via a network. One of skill in the art will appreciate alternatives to the examples presented above that remain within both the scope and the spirit of the present invention.

As illustrated, portable electronic device 120 may include a display 125 that is configured to display textual, graphical, and/or video content generated and/or received by portable electronic device 120. For example, the display 125 may present a textual listing of categories, information related to one or more categories, and/or information without association to a category. Further, portable electronic device 120 may present, via audio signals, the same listing of categories, information related to one or more categories, and/or information without association to a category. A category, in the context of the present invention, is represented by a system or method of classification. In an exemplary embodiment the category may include geographically indexed or associated information.

As shown in FIG. 1, a user 110 communicates with a mobile search apparatus 140 via network 130 and, in some embodiments, other apparatuses (not shown). The communication between user 110 and mobile search apparatus 140 may be initiated by methods known in the art including, but not by way of limitation, the dialing of a phone number or other dialing code associated with the apparatus 140. One of skill in the art will appreciate alternative methods for initiating communication between the user 110 and the apparatus 140 while remaining within both the scope and the spirit of the present invention. Such alternative methods may include transmitting a Web site address or a text message. Further, as known in the art, the communication exchange may comprise transmitting and receiving various communication signals containing data, unique identifying information, geographical information, and commands.

Mobile search apparatus 140 can provide information to the portable electronic device 120 in response to a command from the user 110 via the portable electronic device 120. The information may be stored in a database or other data-store and organized in a predetermined manner prior to it being presented to the user 110. The organization of the information may be performed by mobile search apparatus 140, portable electronic device 120 or another apparatus (not shown) in communication with the mobile search apparatus 140 or the portable electronic device 120.

The predetermined manner in which the information is organized may include a categorical organization structure. For example, the information may be organized into categories 1-N. Each of the categories 1-N may be related to each other through a central theme (e.g., activities associated with a certain geographical area, commercial offerings associated with a specified industry, goods and services offered, location and contact information, price of goods or services etc.); however, one of skill in the art will recognize that the categories 1-N need not be related to each other through a central theme.

Information may also be organized into sub-categories that provide organization of information pertaining to certain parent categories belonging to the group of categories 1-N. There may be any number of sub-categories that pertain to an individual parent category, and such a number of sub-categories does not necessarily have to be the same in value for each parent category. In one embodiment of a mobile search apparatus data stored in the groups may relate to companies that have purchased the right to be represented in the database. In another embodiment, the data may be sorted based on the amount paid by a company. One feature of this embodiment is that companies desiring their information to appear higher on a list may enter into financial relationships and pay more for the right to be listed first.

By way of example, FIG. 1 illustrates an embodiment where mobile search apparatus 140 organizes the information before providing the organized information to the portable electronic device 120. One of ordinary skill in the art will appreciate that the information organized by the mobile search apparatus 140 need not be permanently stored by mobile search apparatus 140, and may therefore be stored in memory directly or indirectly accessible by mobile search apparatus 140.

In one embodiment, the categories and/or sub-categories are organized based on a payment structure. Such a payment structure could allow certain entities (e.g., commercial businesses, individuals, etc.) to pay for placement of their information in the list of categories and/or subcategories. Additionally, a payment structure may allow a company to insert advertising content to be delivered to a portable electronic device during the search process. One of skill in the art will recognize that the organization of the information may be formed using a variety of methods that may or may not include a payment structure.

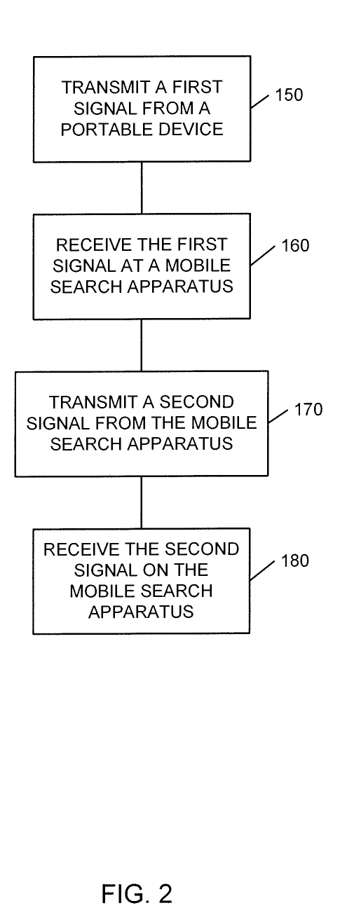

Attention is now drawn to FIG. 2, which illustrates a process flow diagram representative of the operation of an exemplary embodiment. As shown in FIG. 2, flow begins in block 150 where a portable electronic device 120 transmits a first communication signal to a mobile search apparatus 140 on a network 130. In one embodiment, the communication signal may comprise a unique identifier that may be related to a geographical location. It should be appreciated that this unique identifier may be a phone number conforming with a numbering plan similar to the North American Numbering Plan (NANP).

By way of example and not limitation, the NANP is an integrated telephone numbering plan adopted by 24 countries and territories. It consists of a three digit area code (also known as a numbering plan area code) and seven digits that direct the signal to a particular region on the Public Switched Telephone Network (PSTN). In the NANP, the three digits following the numbering plan area code are known as the Exchange code. In many environments, the combination of area code and exchange code relate to a specific geographic region. As is known in the art, other dialing code systems exist and may be used to practice the provided embodiments. For example, there are alpha-numeric dialing codes that may contain non-numerical characters. These dialing codes may additionally relate to specific geographic locations.

Returning to FIG. 2, mobile search apparatus 140 may receive the signal from portable electronics device 120 across network 130. As is known in the art network 130 may comprise a variety network topologies and involve a number of communications technologies. As used herein network may comprise a wireless network, a wired network, a network wherein portions of the network are wireless and other portions wired. Some networks may include fiber optic communications media. Exemplary networks include but are not limited to wireless local area networks, local area networks, the public switched telephone network, cellular communications networks, wide area networks, the Internet, and Voice Over Internet Protocol (VIOP) networks. Some embodiments of present invention are not therefore limited with respect to the particular network topology, configuration, or underlying technology.

Mobile search apparatus 140 may then respond to portable electronics device 120 by transmitting a signal containing data in block 170. In some embodiments, this data may comprise information about what the mobile search apparatus has available for a given geographic location. In other embodiments, this signal may comprise voice data intended to be played on portable electronic device 120. In other embodiments this data may comprise a list formatted textually for display on portable electronic device 120. In alternate embodiments, this data may comprise a list of available products and services in the geographical region. For example, a user may send a message to a specific unique identifier such as #555Restaurants. Upon receiving this message mobile search apparatus 140 may respond with a list of restaurants in the 555 area code. Flow continues to block 180 where portable electronic device 120 received the signal transmitted from mobile search apparatus 140.

One feature of this embodiment is that it allows a user 110 to interact with a mobile search apparatus 140 configured to provide information relevant to the geographical location of interest. In this embodiment, the user 110 may request a listing of information available from mobile search apparatus 140, then based on this information may request specific information from the list. As is known in the art, the initiation of the request may take the form of recognition of the users voice or it may come from another input by the user on portable electronic device 120. As stated above the information provided by mobile search apparatus 140 may be in the form of a voice signal or may be textually formatted. In one embodiment, the textually formatted data may be transmitted from the mobile search apparatus 140 in the form of a webpage. Further, in this first exchange of data, the data may include a list of categories (e.g., a short menu), information related to one or more categories, and/or information without association to a category. Additionally, the first content may be presented to the user 110 via a display 125 connected to portable electronics device 120 and/or via audio signals developed by the device 120 through an attached speaker. In an exemplary embodiment, the first content is delivered via a Wireless Application Protocol (WAP) browser; however, one of skill in the art will recognize alternative delivery methods that enable the user 110 to receive the first content

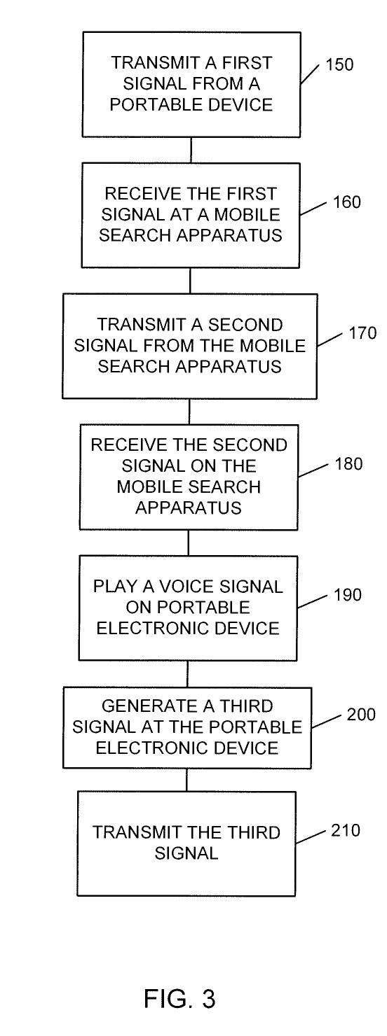

FIG. 3 illustrates an exemplary flow of communication in a provided embodiment. In this embodiment, like the above embodiment, flow begins at block 150 where a portable electronic device 120 transmits a first communication signal to a mobile search apparatus 140 on a network 130. Like the above embodiment, the communication signal may comprise a unique identifier that is related to a geographical location. Similarly to the above embodiment, in block 160 mobile search apparatus 140 may receive the signal from portable electronics device 120 across network 130. Flow continues to block 170 where Mobile search apparatus 140 may then respond to portable electronics device 120 by transmitting a signal containing data. As discussed above this data may be related to the categories of available information on mobile search apparatus 140 or may comprise specific requested information. In block 180 the portable electronic device 120 receives the signal from mobile search apparatus 140.

In one embodiment the signal received from mobile search apparatus is a voice message which lists the categories of available information. In this embodiment, the portable electronics device 120 may play the voice through an attached speaker in block 190. Flow then continues to block 200 where a response signal is generated on the portable electronics device 120. This response signal may comprise a voice recognized signal or may include formatted text. Additionally, the response signal may include a user 110's selection of information from a list of categories. Flow then continues to block 210 where the portable electronic device 120 transmits a signal back to the mobile search apparatus 140.

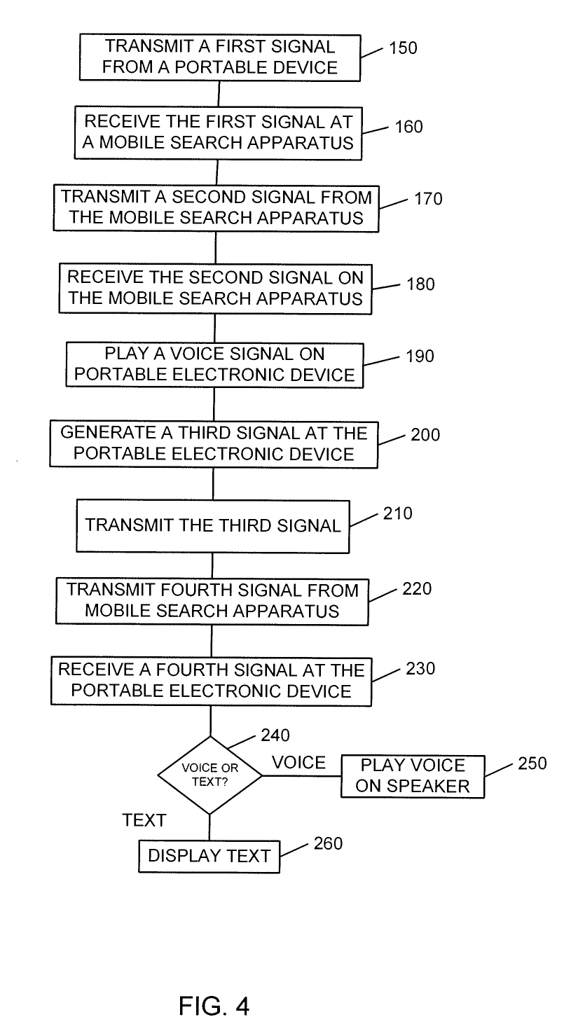

A further embodiment of a network configuration is illustrated in FIG. 4. In this embodiment, like those listed above, flow begins at block 150 where a portable electronic device 120 transmits a first communication signal to a mobile search apparatus 140 on a network 130. Like the above embodiment, the communication signal may comprise a unique identifier that is related to a geographical location. Similarly to the above embodiment, in block 160 mobile search apparatus 140 may receive the signal from portable electronics device 120 across network 130. Flow continues to block 170 where Mobile search apparatus 140 may then respond to portable electronics device 120 by transmitting a signal containing data. As discussed above this data may be related to the categories of available information on mobile search apparatus 140 or may comprise specific requested information. In block 180 the portable electronic device 120 receives the signal from mobile search apparatus 140.

In one embodiment the signal received from mobile search apparatus is a voice message which lists the categories of available information. In this embodiment, the portable electronics device 120 may play the voice through an attached speaker in block 190. Flow then continues to block 200 where a response signal is generated on the portable electronics device 120. This response signal may comprise a voice recognized signal or may include formatted text. Additionally, the response signal may include a user 110's selection of information from a list of categories. Flow then continues to block 210 where the portable electronic device 120 transmits a signal back to the mobile search apparatus 140.

Flow the continues to block 220 where a fourth communication signal is transmitted from mobile search apparatus 140. This signal may comprise data related to a specific inquiry by user 110. For example, in some of the above embodiments, a first request is made from the portable electronic device 120 through the first transmitted signal. The mobile search apparatus 140 may respond with a list of available information in the form of a menu. A user 110 may decide to receive information on movie theaters in his/her geographical region. The next signal from mobile search apparatus 140 may include a list of theaters which is selectable. A user may select a theater and a further signal from mobile search apparatus may include show times. Similar to the above this signal may comprise a voice message or a textually formatted message. In block 240 the portable electronic device 120 may decide on the format, if it determined to be a voice message in block 240, flow continues to block 250 where the voice is played on a speaker attached to portable electronic device 120. If in block 260 it is determined that the signal contains textually formatted data flow continues to block 260 where the message is displayed on a display 125 attached to portable electronic device 120. In like manner a portable electronic device 120 may make multiple requests for searches from mobile search apparatus 140.

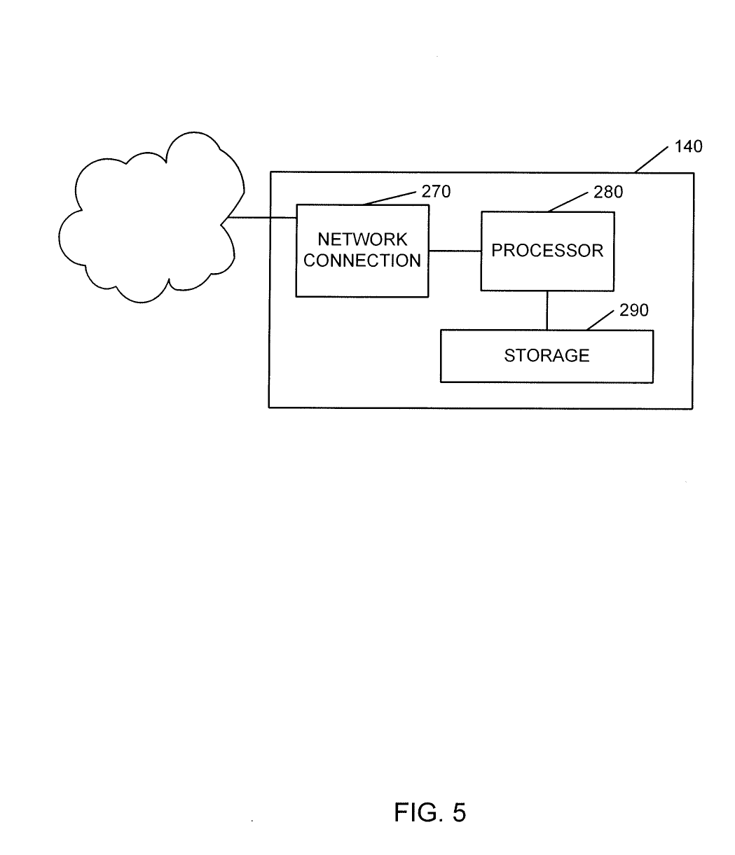

FIG. 5 illustrates an embodiment of a mobile search apparatus 140 consistent with various provided embodiments. As stated above, mobile search apparatus 140 may comprise a computer, a desktop computer, a laptop computer, or other similar device capable of being configured to provide search services consistent with the above embodiments. In an exemplary embodiment, mobile search apparatus 140 may comprise a network connection 270 configured to send and receive signals to and from network 130. Mobile search apparatus 140 may additionally include a processor 280 and a storage medium. A number of processors 280 and storage media 290 are known in the art and may be used to practice the embodiments provided. Additionally, it is important to note that storage media 290 may be external to mobile search apparatus 140.

In one embodiment storage media 290 may include machine executable instruction which configure mobile search apparatus 140 to provide the search services described in the above embodiments. Further, as described in connection with FIG. 1, storage media may contain s plurality of catagories of data which may be further broken down into sub-categories. As described above, the data may be stored in a database or other data store residing on storage media 290 or at another location external but connected to mobile search apparatus 140. In some embodiments the categories may be kept on another device on network 130 and accessed by mobile search apparatus 140 when requested by portable electronic device 120. In one embodiment, the data in the categories may be ordered for priority delivery to a portable electronic device based on a financial relationship. A company may choose to have their information provided to users 110 within a geographical area and pay for this service. Further, the content may be ordered by a financial priority allowing companies to pay to have their products and services listed first.

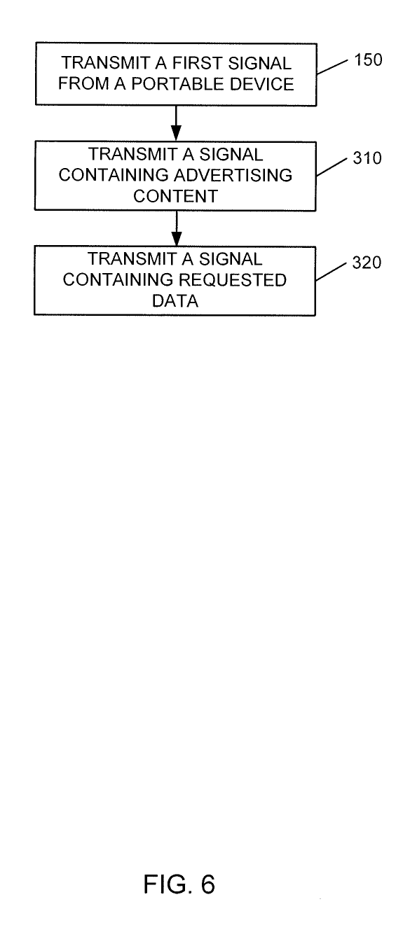

In a further embodiment, illustrated in FIG. 6, advertising content may be interspersed with the desired signals. In this embodiment, flow begins in block 150 like previous embodiments. In block 150 a portable electronic device 120 transmits a first communication signal to a mobile search apparatus 140 on a network 130. Flow then continues to block 310 where a the mobile search apparatus 140 transmits a signal containing advertising content before moving to block 320 where it transmits a signal containing the requested data. In this exemplary embodiment, the advertising content may or may not be related to the information requested by user 110. Additionally, the advertising content is shown as the first transmission from mobile search apparatus. It may also be transmitted at any time during the exchange of communication signals between portable electronic device 120 and mobile search apparatus 140. One of skill in the art will appreciated alternative embodiments where the first advertisement is not necessarily delivered before the delivery of the first content. The invention should not therefore be limited with respect to the content of the advertising nor the timing of transmission of advertising content.

One feature of this embodiment is that it allows advertisers to reach users 110 who are inquiring about goods and services in a geographical location. This targeted advertising provides for a more efficient use of advertiser resources.

Thus, it is seen that a system, method and apparatus for mobile search from portable electronics are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of retrieving information on an electronic device, the method comprising
transmitting a first signal to a network from a portable electronic device, the signal comprising a unique identifier, the unique identifier relating to a geographical location;
receiving the transmitted first signal at a mobile search apparatus on the network, the mobile search apparatus comprising a plurality of geographically referenced categories of data;
transmitting a second signal to the network from the mobile search apparatus, the second signal comprising a first data content; and
receiving the first data content on the portable electronic device.

2. The method of claim 1, wherein the network comprises a wireless communication network.

3. The method of claim 2, wherein the wireless communication network comprises a network selected from a group consisting of: a local area network; a public switched telephone network; a cellular communication network; a wide area network; and a voice over internet protocol network.

4. The method of claim 1, wherein the portable electronic device comprises a device selected from a group consisting of a cellular telephone; a telephone, a personal digital assistant, a computer, a laptop computer, and a handheld communication device.

5. The method of claim 1, wherein the unique identifier comprises an identifier selected from a group consisting of a dialing code and a phone number.

6. The method of claim 1, wherein the unique identifier comprises a numbering plan area code and an exchange code.

7. The method of claim 1, wherein the mobile search apparatus comprises an apparatus selected from a group consisting of: a computer, a desktop computer, and a laptop computer.

8. The method of claim 1, wherein at least one of the plurality of geographically referenced categories of data comprises data selected from a group consisting of: a location, a phone number, a dialing code, a service, a product, and a price.

9. The method of claim 1, wherein the first data content comprises a voice signal, the method further comprising playing the voice signal on a speaker in the portable electronic device.

10. The method of claim 9, further comprising transmitting a third signal from the portable electronic device in response to receiving the voice signal.

11. The method of claim 10, wherein the third signal comprises a signal generated by voice recognition.

12. The method of claim 10, wherein the third signal comprises a dual tone multi-frequency signal.

13. The method of claim 10, further comprising receiving a fourth signal on the portable electronic device, the fourth signal comprising data from at least one of the plurality of geographically referenced categories.

14. The method of claim 1, wherein the first data content comprises a textual list of at least one of the plurality of geographically referenced categories of data, the method further comprising displaying the textual list on a display connected to the portable electronic device.

15. The method of claim 14, further comprising transmitting a third signal, from the portable electronic device, the third signal comprising a selection of at least one of the plurality of geographical referenced categories.

16. The method of claim 15, further comprising receiving the third signal at the mobile search apparatus and transmitting a fourth signal from the mobile search apparatus, the fourth signal comprising data from a geographically referenced category selected in the third signal.

17. The method of claim 15, wherein the fourth signal comprises a voice signal, the method further comprising playing the voice signal on a speaker connected to the portable electronic device.

18. The method of claim 15, wherein the fourth signal comprises a textually formatted signal, the method further comprising displaying the textually formatted signal on a display connected to the portable electronics device.

19. The method of claim 1, wherein the plurality of geographically referenced categories of data are ordered by a payment policy.

20. A communication network comprising:
at least one portable electronic device and a mobile search apparatus,
the portable electronic device configured to transmit a first signal to a network, the signal comprising a unique identifier, the unique identifier relating to a geographical location;
the mobile search apparatus comprising a plurality of geographically referenced categories of data, the mobile search apparatus being configured to receive the transmitted first signal from the network and transmit a second signal comprising a first data content;
the portable electronic device being further configured to receive the second signal.

21. The communication network of claim 20, wherein the network comprises a wireless communication network.

22. The communication network of claim 21, wherein the wireless communication network comprises a network selected from a group consisting of: a local area network; a public switched telephone network; a cellular communication network; a wide area network; and a voice over internet protocol network.

23. The communication network of claim 20, wherein the portable electronic device comprises a device selected from a group consisting of a cellular telephone; a telephone, a personal digital assistant, a computer, a laptop computer, and a handheld communication device.

24. The communication network of claim 20, wherein the unique identifier comprises an identifier selected from a group consisting of a dialing code, and a phone number.

25. The communication network of claim 20, wherein the unique identifier comprises a numbering plan area code and an exchange code.

26. The communication network of claim 20, wherein the mobile search apparatus comprises an apparatus selected from a group consisting of: a computer, a desktop computer, and a laptop computer.

27. The communication network of claim 20, wherein at least one of the plurality of geographically referenced categories of data comprises data selected from a group consisting of: a location, a phone number, a dialing code, a service, a product, and a price.

28. The communication network of claim 20, wherein the first data content comprises a voice signal, the method further comprising playing the voice signal on a speaker in the portable electronic device.

29. The communication network of claim 28, wherein the portable electronic device is further configured to transmit a third signal from the portable electronic device in response to receiving the voice signal.

30. The communication network of claim 29, wherein the third signal comprises a signal generated by voice recognition.

31. The communication network of claim 29, wherein the third signal comprises a dual tone multi-frequency signal.

32. The communication network of claim 29, wherein the portable electronic device is further configured to receive a fourth signal, the fourth signal comprising data from at least one of the plurality of geographically referenced categories.

33. The method of claim 20, wherein the first data content comprises a textual list of at least one of the plurality of geographically referenced categories of data, the portable electronic device being further configured to display the textual list on a display connected to the portable electronic device.

33. The communication network of claim 33, wherein the portable electronic device is further configured to transmit a third signal, the third signal comprising a selection of at least one of the plurality of geographical referenced categories.

34. The communication network of claim 33, wherein the mobile search apparatus is further configured to receive the third signal and transmit a fourth signal, the fourth signal comprising data from a geographically referenced category selected in the third signal.

35. The communication network of claim 34, wherein the fourth signal comprises a voice signal, the portable electronic device being further configured to play the voice signal on a speaker connected to the portable electronic device.

36. The communication network of claim 34, wherein the fourth signal comprises a textually formatted signal, the portable electronic device being further configured to display the textually formatted signal on a display connected to the portable electronics device.

37. The communication network of claim 1, wherein the plurality of geographically referenced categories of data are ordered by a payment policy.

38. A mobile search apparatus comprising:
a network connection connected to a network, the network connection being configured to receive a first signal from a portable electronic device, the signal comprising a unique identifier, the unique identifier relating to a geographical location, the network connection being further configured to transmit a second signal comprising a first data content; and
a data storage, the data storage comprising a plurality of geographically referenced categories of data.

39. The mobile search apparatus of claim 38, wherein the network comprises a wireless communication network.

40. The mobile search apparatus of claim 39, wherein the wireless communication network comprises a network selected from a group consisting of: a local area network; a public switched telephone network; a cellular communication network; a wide area network; and a voice over internet protocol network.

41. The mobile search apparatus of claim 38, wherein the portable electronic device comprises a device selected from a group consisting of a cellular telephone; a telephone, a personal digital assistant, a computer, a laptop computer, and a handheld communication device.

42. The mobile search apparatus of claim 38, wherein the unique identifier comprises an identifier selected from a group consisting of a dialing code and a phone number.

43. The mobile search apparatus of claim 38, wherein the unique identifier comprises a numbering plan area code and an exchange code.

44. The mobile search apparatus of claim 38, wherein the mobile search apparatus comprises an apparatus selected from a group consisting of: a computer, a desktop computer, and a laptop computer.

45. The mobile search apparatus of claim 44, wherein at least one of the plurality of geographically referenced categories of data comprises data selected from a group consisting of: a location, a phone number, a dialing code, a service, a product, and a price.

46. The mobile search apparatus of claim 38, wherein the first data content comprises a voice signal, the method further comprising playing the voice signal on a speaker in the portable electronic device.

47. The mobile search apparatus of claim 46, wherein the portable electronic device is further configured to transmit a third signal in response to receiving the voice signal.

48. The mobile search apparatus of claim 47, wherein the third signal comprises a signal generated by voice recognition.

49. The mobile search apparatus of claim 47, wherein the third signal comprises a dual tone multi-frequency signal.

50. The mobile search apparatus of claim 47, wherein the mobile search apparatus is further configured to transmit a fourth signal to the portable electronic device, the fourth signal comprising data from at least one of the plurality of geographically referenced categories.

51. The mobile search apparatus of claim 38, wherein the first data content comprises a textual list of at least one of the plurality of geographically referenced categories of data, the mobile electronic device being further configured to display the textual list on a display connected to the portable electronic device.

52. The mobile search apparatus of claim 51, wherein the mobile search apparatus is further configured to receive a third signal, the third signal comprising a selection of at least one of the plurality of geographical referenced categories.

53. The mobile search apparatus of claim 51, wherein the mobile search apparatus is further configured to receive the third signal and transmit a fourth signal, the fourth signal comprising data from a geographically referenced category selected in the third signal.

54. The mobile search apparatus of claim 53, wherein the fourth signal comprises a voice signal, the portable electronic device being further configured to play the voice signal on a speaker connected to the portable electronic device.

55. The mobile search apparatus of claim 53, wherein the fourth signal comprises a textually formatted signal, the portable electronic device being further configured to display the textually formatted signal on a display connected to the portable electronics device.

56. The mobile search apparatus of claim 38, wherein the plurality of geographically referenced categories of data are ordered by a payment policy.
